(19) United States
(12) Patent Application Publication
(10) Pub. No.: US 2026/0140994 A1
(43) Pub. Date: May 21, 2026

(54) RETRIEVAL AUGMENTED MULTIPLE CHOICE QUESTION AND ANSWER GENERATION ON SEARCH QUERIES

(71) Applicant: Yahoo Assets LLC, New York, NY (US)

(72) Inventor: Seung Byum Seo, Champaign, IL (US)

(21) Appl. No.: 18/951,826

(22) Filed: Nov. 19, 2024

(51) Int. Cl. G06F 16/383; G06F 16/33; G06F 16/332

(52) U.S. Cl. CPC G06F 16/383; G06F 16/3326; G06F 16/3344

(57) ABSTRACT

One or more computing devices and/or methods for retrieval augmented multiple choice question and answer generation on search queries are provided. A pregeneration prompt may be generated based upon a user input query, one or more chunks of content, and/or instructions for a model. The pregeneration prompt is input into the model to generate an initial question. Another prompt is generated based upon the initial question, the one or more chunks of content, and/or the instructions. The prompt is input into the model to generate question and answer content in a multiple choice format that is provided through a user interface for user engagement.

### BACKGROUND

Machine learning models and artificial intelligence (AI) are used for many purposes such as for conversational AI and chatbots, optimizing cloud storage and cloud application hosting, providing customer service functionality, process automation, recommendation generation, and/or other use cases. AI functionality utilizes machine learning models that are trained to generate outputs such as predictions, responses to human queries, and/or other types of information.

### SUMMARY

In accordance with the present disclosure, one or more computing devices and/or methods for retrieval augmented multiple choice question and answer generation on search queries are provided. In an example, documents may be parsed into chunks that are stored within a repository. The chunks may be subsequently used for processing user input queries. A user input query may be received through a search interface. Similarity scores, corresponding to similarities between the user input query and the chunks of content, are determined. One or more chunks are selected from the repository based upon similarity scores between the user input query and the one or more chunks (e.g., chunks of content relevant to the user search query may be retrieved). A pregeneration prompt is generated based upon the user input query, the one or more chunks, and instructions for a model. The pregeneration prompt is input into the model to generate an initial question. Another prompt is generated based upon the initial question, the one or more chunks, and the instructions for the model. The prompt is input into the model to generate question and answer content in a multiple choice format. The question and answer content in the multiple choice format is provided through a user interface for user engagement.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4 is a flow chart illustrating an example method for retrieval augmented multiple choice question and answer generation on search queries.

FIG. 5A is a component block diagram illustrating an example system for retrieval augmented multiple choice question and answer generation on search queries, where chunks of content are stored into a repository.

FIG. 5B is a component block diagram illustrating an example system for retrieval augmented multiple choice question and answer generation on search queries, where an initial question is obtained from a model.

FIG. 5C is a component block diagram illustrating an example system for retrieval augmented multiple choice question and answer generation on search queries, where question and answer content in multiple choice format is provided through a user interface.

FIG. 6A illustrates an example of chunks parsed from a document.

FIG. 6B illustrates an example of a vector embedding.

FIG. 7 illustrates an example of a similarity function.

FIG. 8 illustrates an example of a pregeneration prompt.

FIG. 9 illustrates an example of a prompt.

FIG. 10 is a component block diagram illustrating an example system for retrieval augmented multiple choice question and answer generation on search queries.

FIG. 11 is a component block diagram illustrating an example system for retrieval augmented multiple choice question and answer generation on search queries.

FIG. 12 is an illustration of a scenario featuring an example non-transitory machine readable medium in accordance with one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

### 1. Computing Scenario

The following provides a discussion of some types of computing scenarios in which the disclosed subject matter may be utilized and/or implemented.

### 1.1. Networking

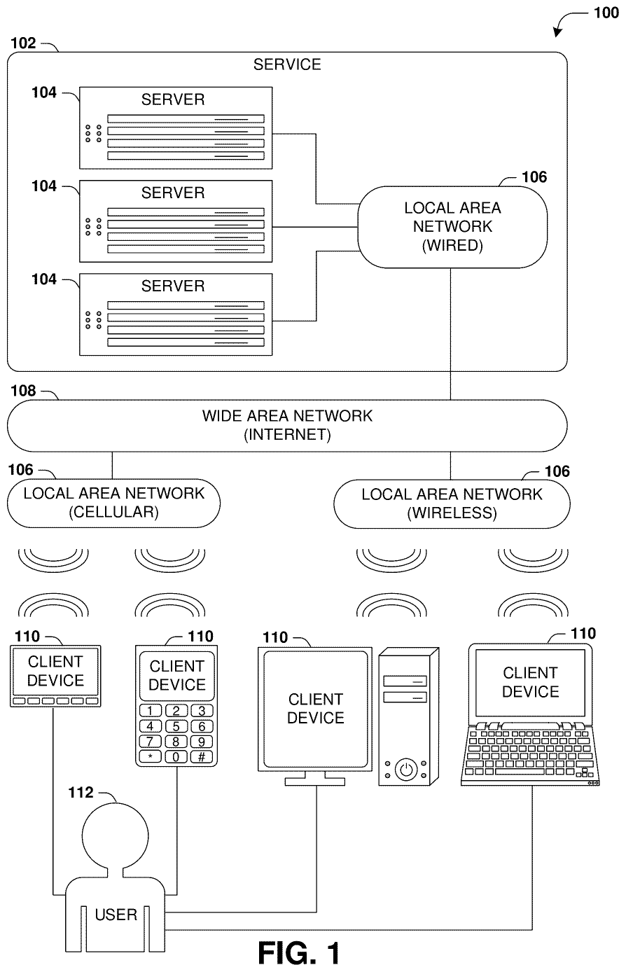

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fiber Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ differing architectures, may be compliant or compatible with differing protocols and/or may interoperate within the local area network 106. Additionally, a variety of local area networks 106 may be interconnected; e.g., a router may provide a link between otherwise separate and independent local area networks 106.

In the scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 (and/or via a wired network) provided by a location such as the user's home or workplace (e.g., a WiFi (Institute of Electrical and Electronics Engineers (IEEE) Standard 802.11) network or a Bluetooth (IEEE Standard 802.15.1) personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

### 1.2. Server Configuration

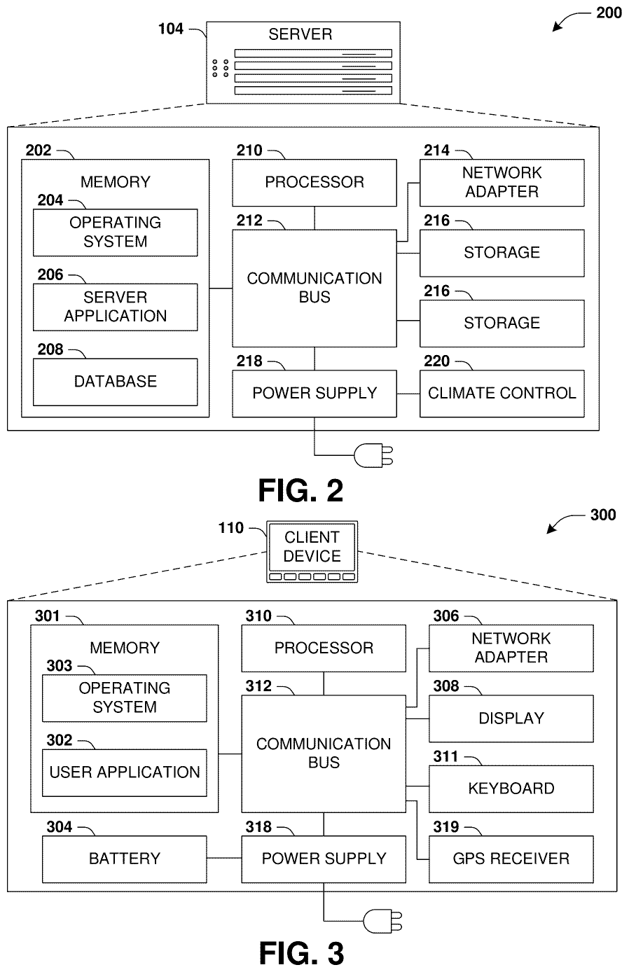

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

### 1.3. Client Device Configuration

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 310 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 311, a mouse, a microphone, a camera, and/or a touch-sensitive component of the display 308; and/or environmental sensors, such as a global positioning system (GPS) receiver 319 that detects the location, velocity, and/or acceleration of the client device 110, a compass, accelerometer, and/or gyroscope that detects a physical orientation of the client device 110. Other components that may optionally be included with the client device 110 (though not shown in the schematic architecture diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

In some scenarios, as a user 112 interacts with a software application on a client device 110 (e.g., an instant messenger and/or electronic mail application), descriptive content in the form of signals or stored physical states within memory (e.g., an email address, instant messenger identifier, phone number, postal address, message content, date, and/or time) may be identified. Descriptive content may be stored, typically along with contextual content. For example, the source of a phone number (e.g., a communication received from another user via an instant messenger application) may be stored as contextual content associated with the phone number. Contextual content, therefore, may identify circumstances surrounding receipt of a phone number (e.g., the date or time that the phone number was received), and may be associated with descriptive content. Contextual content, may, for example, be used to subsequently search for associated descriptive content. For example, a search for phone numbers received from specific individuals, received via an instant messenger application or at a given date or time, may be initiated. The client device 110 may include one or more servers that may locally serve the client device 110 and/or other client devices of the user 112 and/or other individuals. For example, a locally installed webserver may provide web content in response to locally submitted web requests. Many such client devices 110 may be configured and/or adapted to utilize at least a portion of the techniques presented herein.

### 2. Presented Techniques

One or more computing devices and/or techniques for retrieval augmented multiple choice question and answer generation on search queries are provided. The disclosed techniques provide for a generative artificial intelligence (AI) solution that retrieves documents and generates questions and answers in multiple choice format on search queries. Conventional implementations of generative AI models may be internally used for improving the efficiency of business operations and computing environments, such as for more efficiently storing data within a cloud computing environment. Unfortunately, these conventional implementations of generative AI models, such as customer-facing products, chat bots, customer service agents, etc., often result in low user engagement, a lack of trustworthiness, and/or hallucinations where a model produces inaccurate or nonsensical information. Most generative AI applications provide a response (answer) in verbose formats, such as through a paragraph of text, a numbered list, an itemized list, etc. These formats result in low user engagement because there is little opportunity for user interaction. The responses may be long-winded, thus leading users to leave the page without a single interaction or click.

The disclosed technique for retrieval augmented multiple choice question and answer generation overcomes these technical problems of conventional implementations of generative AI models that produce inaccurate or nonsensical information, thus resulting in low user engagement and/or a lack of trustworthiness. In particular, the disclosed techniques significantly improve the output generated by models. The output is improved by controlling the models using multiple iterations of prompts to create question and answer content in a multiple choice format that will significantly improve user engagement due to the increased relevancy and accuracy of the output. As opposed to verbose outputs provided by conventional implementations of generative AI models, the question and answer content in the multiple choice format provides high user engagement where users can select an answer, click a button to see whether the answer is correct, and/or read an explanation about the correct answer.

The disclosed techniques add trustworthiness to the generated question and answer content, which is a struggle for conventional implementations of generative AI models that end up relying on extensive human effort and curation to generate questions and answers that are trustworthy and accurate, or are created through other non-trivial means to ensure factuality. The disclosed techniques improve trustworthiness by generating explanations as part of the question and answer content, such as an explanation as to why an answer is the correct answer and/or why incorrect answers are incorrect. The explanations may be provided to the user, and may be used by the model for verifying the factuality at each stage of processing. Thus, both user and the system can verify the factuality of the question and answer content.

The disclosed techniques reduce the risk of the model, such as a large language model (LLM), hallucinating the answer. The risk of hallucination is reduced because the disclosed techniques utilize trusted documents for generating the output, thus resulting in questions and answers having source attributes from trusted sources (e.g., articles from an online encyclopedia, trusted news source, etc.). Because the inputs are trusted documents, the outputs from the model are also trusted responses. Furthermore, a series of pregeneration and question and answer generation components of the system verify the confidence of the output (an answer for a question) at each stage. The system may reason confidence values (e.g., “Y” or “N”) through explanation to ensure that the model's reasoning on an answer is correct. The system disqualifies any outputs having a confidence value of “N,” and thus merely question and answer pairs with high confidence are provided to users.

The disclosed system is configured for generating questions and answers in multiple choice format using search queries from users. The system consists of components that perform offline ingestion, retrieval of chunks of content, pregeneration, and question and answer content generation. Unlike pre-trained models such as LLM models, the model generates the output (question and answer content in multiple choice format) based upon trusted documents retrieved from trusted sources. This adds to the trustworthiness of the generated question and answer content, while pre-trained LLMs often memorize or hallucinate the answer. The system generates unique and effective prompts that understand the documents and current time for the question and answer content generation and reasoning. The explanation (e.g., a reason that an answer is the correct answer) and confidence values are used to justify why the generated answers are trustworthy for both the system and users. The system may be incorporated into various generative AI products and systems in order to provide high quality, scalable, and future-proof solutions for various use cases. The system may be implemented as an online solution that provides the question and answer content in real-time in response to user queries, thus resulting in a higher impact and user engagement.

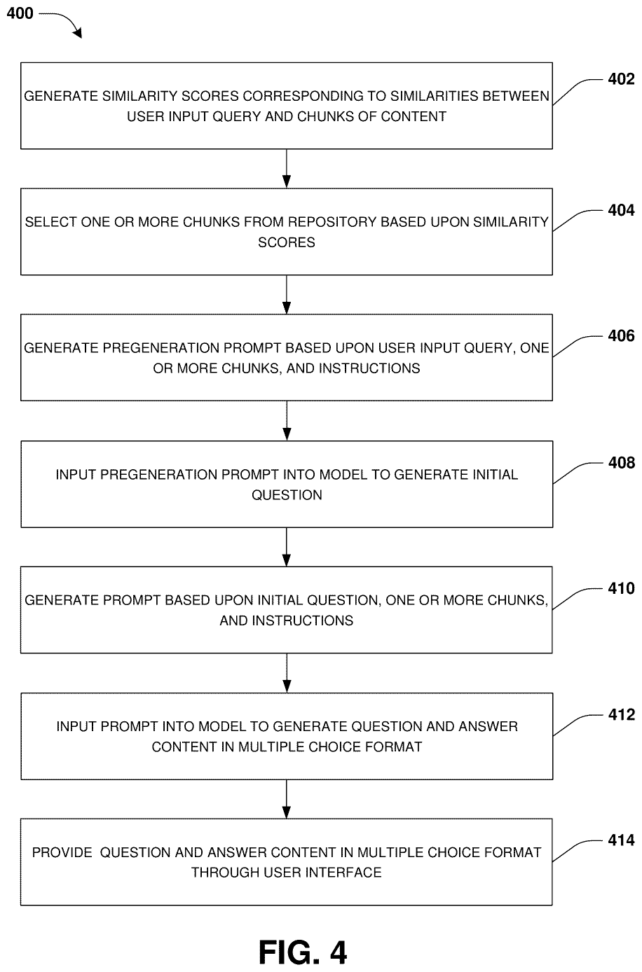

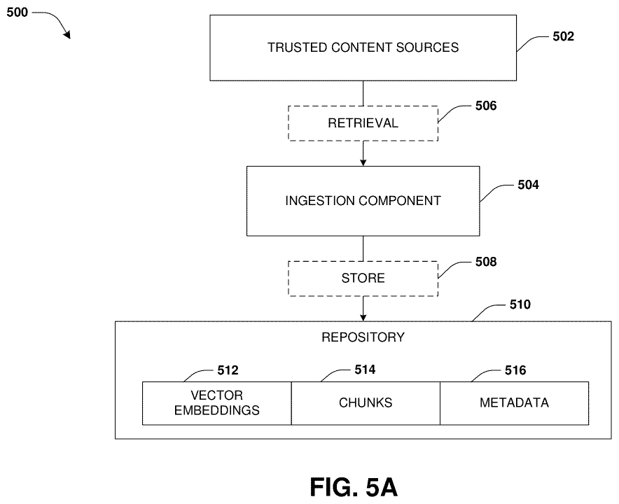

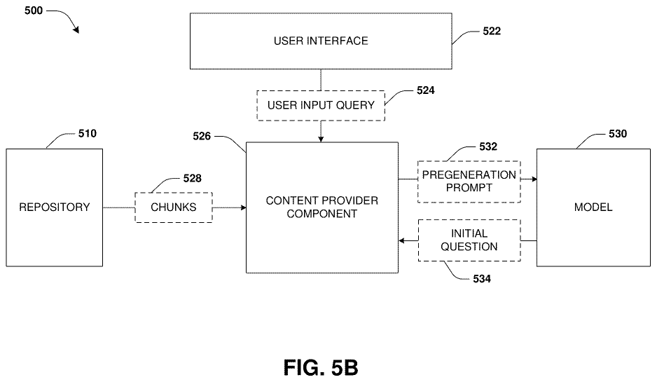

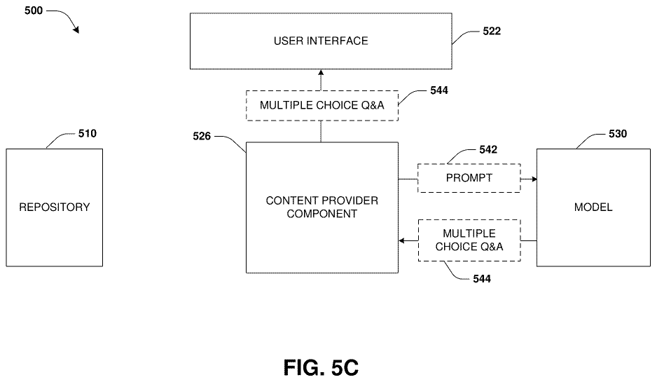

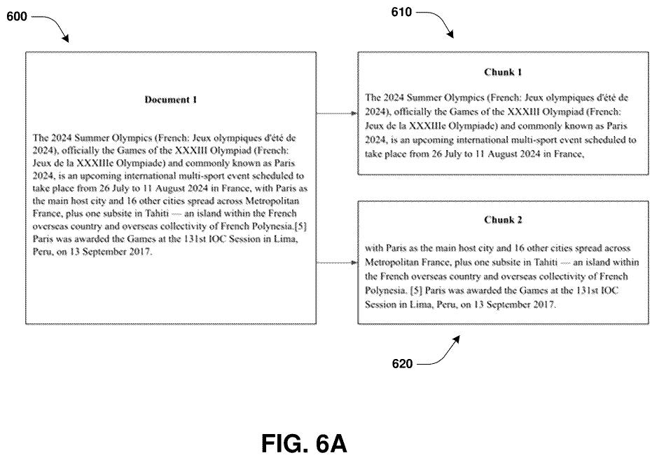

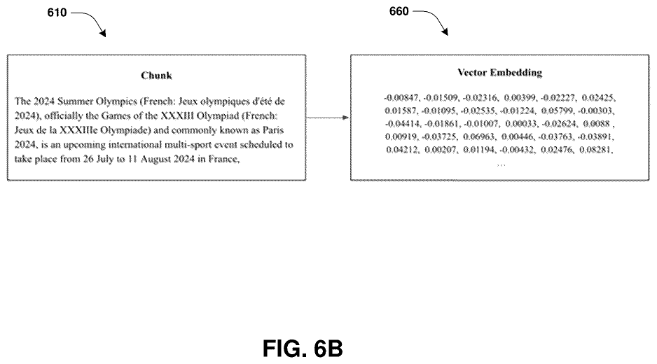

FIG. 4 is a flow chart illustrating an example method 400 for retrieval augmented multiple choice question and answer generation on search queries, which is described in conjunction with system 500 of FIGS. 5A-5C. An ingestion component 504 is configured to ingest documents for populating a repository 510, as illustrated by FIG. 5A. The ingestion component 504 retrieves 506 documents from trusted content sources 502, such as an online encyclopedia service (e.g., crawling webpage articles on various topics such as cars, Olympics, biking, video games, etc.), a trusted news service, etc. A document (e.g., an article about cars, a webpage, content including text, content including an image, content including a video, a social media post, a blog, content within an application, etc.) is parsed into a plurality of chunks 514. A chunk may relate to a portion of a document. In some embodiments, a chunk may be constrained to a certain number of characters, a certain range of characters (e.g., between 400 and 10,000 characters), a minimum number of characters (e.g., at least 400 characters), and/or a maximum number of characters (e.g., 20,000 characters). In some embodiments, the chunks 514 may include overlapping content from the document, such as up to a percentage of allowed overlap (e.g., a first chunk and a second chunk may be allowed to overlap from 0% to 20%). A chunk may be selected to include content that preserves contextual information of the content (e.g., a chunk would include the entirety of text describing how to change a flat tire, as opposed to merely half of the steps described for changing the flat tire). FIG. 6A illustrates an example of a document 600 that is parsed into a first chunk 610 and a second chunk 620.

The ingestion component 504 may generate vector embeddings 512 for the plurality of chunks 514. FIG. 6B illustrates an example of a vector embedding 660 that is generated for the first chunk 610. The ingestion component 504 may store 508 the vector embeddings 512, the plurality of chunks 514, and/or metadata 516 within the repository 510. In some embodiments, the metadata 516 may include a title of a document, a published date of a document, and/or an updated date of when the document was last updated. In this way, the ingestion component 504 may populate the repository 510 offline or separate from a content provider component 526 that performs pregeneration functionality and question and answer content generation in real-time in response to user queries.

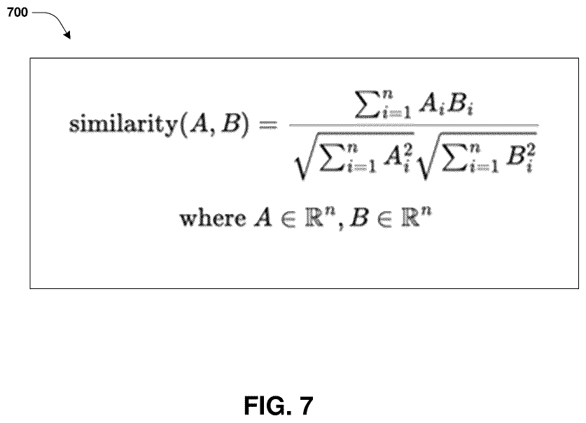

During operation 402 of method 400, the content provider component 526 may receive a user input query 524 through a user interface 522. For example, a user may input a search query through a search engine, such as “latest video games,” which may be received by the content provider component 526 as the user input query 524. The content provider component 526 generates similarity scores corresponding to similarities between the user input query 524 and chunks of content within the repository 510. In some embodiments, the content provider component 526 generates a user input vector embedding for the user input query 524. The content provider component 526 utilizes a similarity function to compare the user input vector embedding to vector embeddings of the chunks to assign the similarity scores relating to how similar a chunk is to the user input query 524 (e.g., chunks of content relating to video games may have higher similarities scores than chunks of content unrelated to video games such as how to change a flat tire). FIG. 7 illustrates an example of a similarity function 700 where A is the user input query 524 and B is a chunk.

During operation 404 of method 400, one or more chunks 528 are selected from the repository 510 based upon the similarities scores between the user input query 524 and the one or more chunks 528, such as where a top N chunks with the highest similarity score are selected because such chunks may have topics more similar to the topic of the user input query 524. In some embodiments, a similarity score threshold is applied to the similarity scores to disqualify chunks with similarity scores below the similarity score threshold. Such chunks are disqualified so that irrelevant chunks are not further considered, which would otherwise decrease the ability for a model 530 (e.g., a generative AI model, an LLM model, etc.) to generate a valid output (e.g., generate a question with a single correct answer from a set of multiple choice answers).

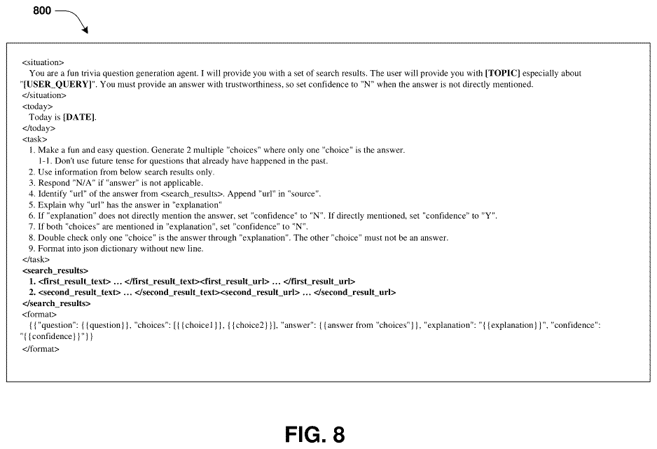

During operation 406 of method 400, the content provider component 526 generates a pregeneration prompt 532 based upon the user input query 524, the one or more chunks 528, and/or instructions for the model 530. FIG. 8 illustrates an example of a pregeneration prompt 800 (pregeneration prompt 532). The pregeneration prompt 532 may include a situation tag, a date tag (e.g., a current date), a task tag, a format tag, and/or other tags. The situation tag may be defined to describe a persona, such as a question answer generation agent (e.g., the model 530 is generate outputs that would be provided by the question answer generation agent to users). The situation tag may include the user input query 524 as a topic for the model 530 to generate an initial question 534 as the question answer generation agent. In some embodiments, the situation tag may be defined as:
“You are a fun trivia question generation agent. I will provide you with a set of search results. The user will provide you with [TOPIC] especially about “[USER_QUERY]”. You must provide an answer with trustworthiness, so set confidence to “N” when the answer is not directly mentioned.”

The task tag may be defined to describe an ordered set of tasks that include one or more tasks that constrain the model 530 to output the initial question 534 having the multiple choice format with multiple answers to a question where only a single answer is correct and all other answers are incorrect. In some embodiments, the task tag may be defined as: 1. Make a fun and easy question. Generate 2 multiple “choices” where only one “choice” is the answer. 1-1. Don't use future tense for questions that already have happened in the past. 2. Use information from below search results only. 3. Respond “N/A” if “answer” is not applicable. 4. Identify “url” of the answer from <search_results>. Append “url” in “source”. 5. Explain why “url” has the answer in “explanation.” 6. If “explanation” does not directly mention the answer, set “confidence” to “N”. If directly mentioned, set “confidence” to “Y”. 7. If both “choices” are mentioned in “explanation”, set “confidence” to “N”. 8. Double check only one “choice” is the answer through “explanation”. The other “choice” must not be an answer. 9. Format into json dictionary without new line.”

The format tag may be defined to describe an expected response format for the initial question 534. Any outputs from the model 530 that do not conform to the expected response format described by the format tag are discarded. In some embodiments, the format tag may be defined as “{{“question”: {{question}}, “choices”: [{{choice1}}, {{choice2}}], “answer”: {{answer from “choices”}}, “explanation”: “{{explanation}}”, “confidence”: “{{confidence}}”}}.”

In some embodiments, the pregeneration prompt 532 includes a search results tag that includes search results from the user input query 524 (e.g., research results obtained by submitting the user input query 524 into a search engine). In some embodiments, the search results tag may be defined as “1. <first_result_text> . . . </first_result_text><first_result_url> . . . </first_result_url>2. <second_result_text> . . . </second_result_text><second_result_url> . . . </second_result_url>.”

During operation 408 of method 400, the pregeneration prompt 532 is input into the model 530 to generate the initial question 534 (a pregeneration question). In some embodiments, the pregeneration prompt 532 is populated with task instructions for the model 530 to assign a confidence value to each potential initial question (e.g., the model 530 may generate a plurality of potential initial questions that could be selected as the initial question 534 output by the model 530). The confidence may have a first value such as “N” corresponding to a low confidence and a second value such as “Y” corresponding to a non-low confidence. A confidence may relate to confident the model 530 is that the output is accurate based upon the instructions within the pregeneration prompt 532. The model 530 may generate the confidence based upon the task instructions. If the confidence of a potential initial question has the first value of a low confidence “N,” then the potential initial question is disqualified from further consideration. If the confidence of the potential initial question has the second value of a non-low confidence “Y,” then the potential initial question is retained for further consideration. In this way, the pregeneration prompt 532 is input into the model 530 to filter potential questions that do not exist within the repository, such as potential questions assigned the confidence with the first value indicating a low confidence. In this way, the model 530 outputs the initial question 534 having a non-low confidence, such as an initial question 534 with a highest confidence.

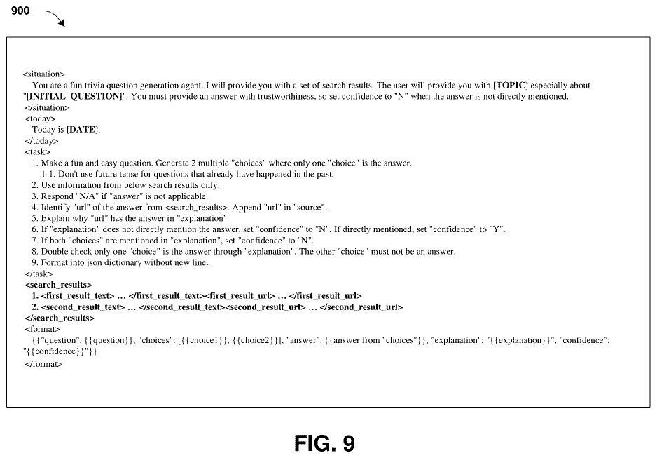

During operation 410 of method 400, the content provider component 526 generates a prompt 542 to input into the model 530 to control the model 530 to generate question and answer content in multiple choice format (multiple choice Q&A 544), as illustrated by FIG. 5C. The content provider component 526 generates the prompt 542 to include the initial question 534, the one or more chunks 514, and/or instructions for the model 530. In some embodiments, the prompt 542 is similar to the pregeneration prompt 532 except that the prompt 542 includes the initial question 534 and does not include the user input query 524. FIG. 9 illustrates an example of a prompt 900.

The prompt 542 may include a situation tag, a date tag (e.g., a current date), a task tag, a format tag, and/or other tags. The situation tag may be defined to describe a persona for the model to generate outputs that would be provided as answers from a question answer generation agent. The situation tag may include the initial question 534 as a topic for the model 530 to generate the question and answer content in the multiple choice format as the question answer generation agent. In some embodiments, the situation tag may be defined as: “You are a fun trivia question generation agent. I will provide you with a set of search results. The user will provide you with [TOPIC] especially about “[INITIAL_QUESTION]”. You must provide an answer with trustworthiness, so set confidence to “N” when the answer is not directly mentioned.”

The task tag may be defined to describe an ordered set of tasks that include one or more tasks that constrain the model 530 to output the question and answer content in the multiple choice format with multiple answers to a question where only a single answer is corrected and all other answers are incorrect. In some embodiments, the task tag may be defined as:
1. Make a fun and easy question. Generate 2 multiple “choices” where only one “choice” is the answer. 1-1. Don't use future tense for questions that already have happened in the past. 2. Use information from below search results only. 3. Respond “N/A” if “answer” is not applicable. 4. Identify “url” of the answer from <search_results>. Append “url” in “source”. 5. Explain why “url” has the answer in “explanation.” 6. If “explanation” does not directly mention the answer, set “confidence” to “N”. If directly mentioned, set “confidence” to “Y”. 7. If both “choices” are mentioned in “explanation”, set “confidence” to “N”. 8. Double check only one “choice” is the answer through “explanation”. The other “choice” must not be an answer. 9. Format into json dictionary without new line.”

The format tag may be defined to describe an expected response format for the question and answer content in the multiple choice format. Any outputs from the model 530 that do not conform to the expected response format described by the format tag are discarded. In some embodiments, the format tag may be defined as “{{“question”: {{question}}, “choices”: [{{choice1}}, {{choice2}}], “answer”: {{answer from “choices”}}, “explanation”: “{{explanation}}”, “confidence”: “{{confidence}}”}}.”

In some embodiments, the prompt 542 includes a search results tag that includes search results from the user input query 524 (e.g., search results returned by a search engine for the user input query 524). In some embodiments, the search results tag may be defined as “1. <first_result_text> . . . </first_result_text><first_result_url> . . . </first_result_url>2. <second_result_text> . . . </second_result_text><second_result_url> . . . </second_result_url>.”

During operation 412 of method 400, the prompt 542 is input into the model 530 to control the model 530 to generate the question and answer content in the multiple choice format (the multiple choice question and answer 544). The question and answer content may include a question, such as “Which sport will make its Olympic debut at the 2024 Summer Olympics?” and multiple potential answers such as “A. Breakdancing,” “B. Surfing,” etc. The question and answer content may specify which answer is the correct answer such as “A. Breakdancing,” and include an explanation as to why the correct answer is correct, such as “According to [1], breakdancing will make its Olympic debut as an optional sport at 2024 Summer Olympics in Paris.” where [1] is a trusted source from which the explanation was derived.

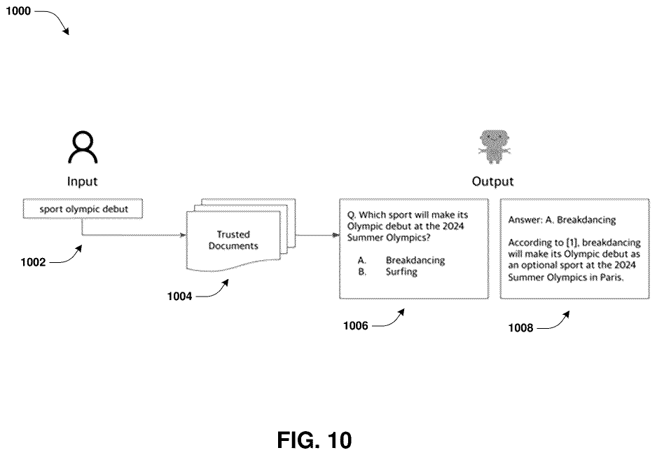

During operation 414 of method 400, the question and answer content in the multiple choice format is provided to the user through the user interface 522 for user engagement. If the user selects an answer, then the correct answer and explanation/reason for why the correct answer is correct is displayed through the user interface 522. FIG. 10 illustrates an example 1000 of a user query input 1002 being used to identify chunks from trusted documents 1004 for generating question and answer content 1006 in the multiple choice format and a correct answer and explanation 1008 that is provided as output to a user, which may be performed by the content provider component 526.

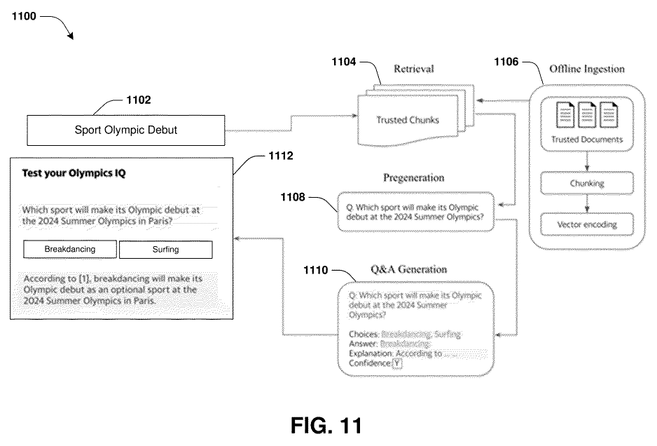

FIG. 11 is a component block diagram illustrating an example system 1100 for retrieval augmented multiple choice question and answer generation on search queries, which may be implement by the content provider component 526. A user input query 1102, such as “sport Olympic Debut” may be received. The user input query 1102 is used to retrieve 1104 one or more chunks of content related to the user input query 1102. Chunks of content may be obtained from a repository that is populated by offline ingestion 1106 with chunks of content parsed from trusted documents. The repository may be populated with vector encodings of the chunks, which may be compared to a vector encoding of the user input query 1102 using a similarity function to identify the one or more chunks as having highest similarity scores above a similarity score threshold. Pregeneration 1108 is performed to construct a pregeneration prompt that is input into a model. Based upon the pregeneration prompt, the model outputs an initial question that is used to create another prompt that is input into the model. Based upon the prompt, the model outputs question and answer content as part of Q&A generation 1110 used to display the question and answer content in a multiple choice format through a user interface 1112.

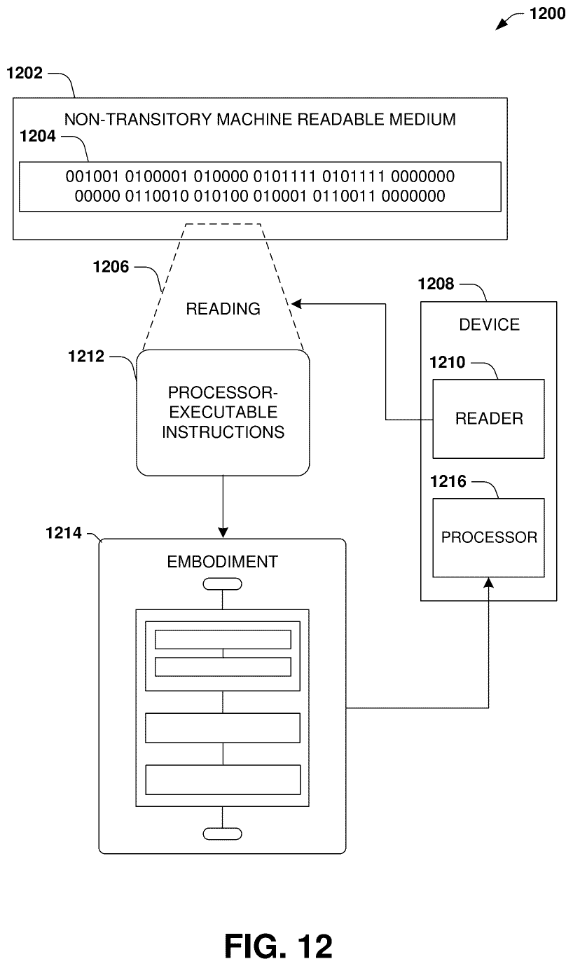

FIG. 12 is an illustration of a scenario 1200 involving an example non-transitory machine readable medium 1202. The non-transitory machine readable medium 1202 may comprise processor-executable instructions 1212 that when executed by a processor 1216 cause performance (e.g., by the processor 1216) of at least some of the provisions herein (e.g., embodiment 1214). The non-transitory machine readable medium 1202 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disc (CD), digital versatile disc (DVD), or floppy disk). The example non-transitory machine readable medium 1202 stores computer-readable data 1204 that, when subjected to reading 1206 by a reader 1210 of a device 1208 (e.g., a read head of a hard disk drive, or a read operation invoked on a solid-state storage device), express the processor-executable instructions 1212. In some embodiments, the processor-executable instructions 1212, when executed, cause performance of operations, such as at least some of the example method 400 of FIG. 4, for example. In some embodiments, the processor-executable instructions 1212 are configured to cause implementation of a system, such as at least some of the example system 50 of FIGS. 5A-5C, for example.

### 3. Usage of Terms

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer and/or machine readable media, which if executed will cause the operations to be performed. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
in response to receiving a user input query, generating similarity scores corresponding to similarities between the user input query and chunks of content within a repository;
selecting one or more chunks from the repository based upon similarity scores between the user input query and the one or more chunks;
generating a pregeneration prompt based upon the user input query, the one or more chunks, and instructions for a model;
inputting the pregeneration prompt into the model to generate an initial question;
generating a prompt based upon the initial question, the one or more chunks, and the instructions for the model;
inputting the prompt into the model to generate question and answer content in a multiple choice format; and
providing the question and answer content in the multiple choice format through a user interface for user engagement.

2. The method of claim 1, wherein the generating the pregeneration prompt further comprises:
populating the pregeneration prompt with a situation tag, a date tag, a task tag, and a format tag.

3. The method of claim 2, comprising:
defining the situation tag to describe a persona as a question answer generation agent and includes the user input query as a topic for the model to generate the initial question as the question answer generation agent.

4. The method of claim 2, comprising:
defining the task tag to describe an ordered set of tasks to be performed by the model, wherein the ordered set of tasks include one or more tasks constraining the model to output the initial question having the multiple choice format with multiple answers where a single answer is correct and other answers are not correct.

5. The method of claim 2, comprising:
defining the format tag to describe an expected response format for the initial question; and
discarding outputs by the model that do not conform to the expected response format described by the format tag.

6. The method of claim 1, wherein the generating the pregeneration prompt further comprises:
populating the pregeneration prompt with task instructions for the model to assign a confidence having a first value or a second value for a potential initial question;
in response to the confidence being set to the first value, disqualifying the potential initial question; and
in response to the confidence being set to the second value, retaining the potential initial question for further consideration.

7. The method of claim 1, comprising:
inputting the pregeneration prompt into the model for filtering potential initial questions that do not exist within the repository.

8. The method of claim 1, comprising:
retrieving a document from a trusted content source;
parsing the document into a plurality of chunks;
generating vector embeddings for each chunk of the plurality of chunks; and
storing the vector embeddings, the plurality of chunks, and metadata information into the repository.

9. The method of claim 8, wherein the metadata information includes a title, a published date, and an updated date of the document.

10. The method of claim 8, comprising:
selecting a first chunk to include a first portion of the document; and
selecting a second chunk to include a second portion of the document, wherein the second portion overlaps the first portion within a percentage of allowed overlap.

11. The method of claim 8, comprising:
selecting a first chunk to include content that preserves contextual information of the content.

12. A non-transitory machine-readable medium having stored thereon processor-executable instructions that when executed cause performance of operations, the operations comprising:
in response to receiving a user input query, generating similarity scores corresponding to similarities between the user input query and chunks of content within a repository;
selecting one or more chunks from the repository based upon similarity scores between the user input query and the one or more chunks;
generating a pregeneration prompt based upon the user input query, the one or more chunks, and instructions for a model;
inputting the pregeneration prompt into the model to generate an initial question;
generating a prompt based upon the initial question, the one or more chunks, and the instructions for the model;
inputting the prompt into the model to generate question and answer content in a multiple choice format; and
providing the question and answer content in the multiple choice format through a user interface for user engagement.

13. The non-transitory machine-readable medium of claim 12, the operations comprising:
generating a user input vector embedding for the user input query;
utilizing a similarity function to compare the user input vector embedding to vector embeddings of the chunks to assign the similarity scores; and
selecting the one or more chunks based upon the one or more chunks having higher similarity scores than other chunks.

14. The non-transitory machine-readable medium of claim 12, the operations comprising:
applying a similarity score threshold to the similarity scores to disqualify chunks with similarities scores below the similarity score threshold.

15. The non-transitory machine-readable medium of claim 12, the operations comprising:
populating the prompt with a situation tag, a date tag, a task tag, and a format tag.

16. The non-transitory machine-readable medium of claim 15, the operations comprising:
defining the situation tag to describe a persona as a question answer generation agent and includes the initial question as a topic for the model to generate the question and answer content in the multiple choice format as the question answer generation agent.

17. The non-transitory machine-readable medium of claim 15, the operations comprising:
defining the task tag to describe an ordered set of tasks to be performed by the model, wherein the ordered set of tasks include one or more tasks constraining the model to output the question and answer content in the multiple choice format with multiple answers where a single answer is correct and other answers are not correct.

18. The non-transitory machine-readable medium of claim 15, the operations comprising:
defining the format tag to describe an expected response format for the question and answer content in the multiple choice format; and
discarding outputs by the model that do not conform to the expected response format described by the format tag.

19. A computing device comprising:
a processor; and
memory comprising processor-executable instructions that when executed by the processor cause performance of operations, the operations comprising:
in response to receiving a user input query, generating similarity scores corresponding to similarities between the user input query and chunks of content within a repository;
selecting one or more chunks from the repository based upon similarity scores between the user input query and the one or more chunks;
generating a pregeneration prompt based upon the user input query, the one or more chunks, and instructions for a model;
inputting the pregeneration prompt into the model to generate an initial question;
generating a prompt based upon the initial question, the one or more chunks, and the instructions for the model;
inputting the prompt into the model to generate question and answer content in a multiple choice format; and
providing the question and answer content in the multiple choice format through a user interface for user engagement.

20. The computing device of claim 19, the operations comprising:
populating the user interface with a question specified by the question and answer content;
populating the user interface with a plurality of answers specified by the question and answer content, wherein the plurality of answers includes a correct answer and one or more incorrect answers; and
in response to a user selecting an answer from the plurality of answers through the user interface, displaying the correct answer and a reason that the correct answer is correct.
